(19) United States
(12) Patent Application Publication
(10) Pub. No.: US 2011/0293790 A1
(43) Pub. Date: Dec. 1, 2011

(54) THERAPEUTIC FOOD FORMULATION

(76) Inventor: George Ewing, Golden Valley, MN (US)

(21) Appl. No.: 13/118,819

(22) Filed: May 31, 2011

Related U.S. Application Data
(60) Provisional application No. 61/349,498, filed on May 28, 2010.

(51) Int. Cl. A23L 1/29; A23L 1/305; A23L 1/302

(52) U.S. Cl. 426/72; 426/648; 426/518

(57) ABSTRACT

A food formulation for treating malnourished individuals is provided. The food formulation may be customized to specific target consumer groups. The food formulation further may comprise a majority of locally available ingredients. In some embodiments, a food formulation is provided comprising proteins, fats, carbohydrates, and nutritional ingredients, and having a relatively high energy content.

This application claims priority to U.S. Application No. 61/349,498, filed May 28, 2010, the content of which is hereby incorporated in its entirety by reference.

### BACKGROUND

There are approximately 1.02 billion people worldwide that are not getting enough food. Of these, approximately 146 million are children. In developing countries, there is a high childhood mortality rate associated with malnutrition. The United Nations has established millennium development goals (MDGs) to improve the quality of life in developing countries. One of these goals deals with the mortality rate of children under 5 years old resulting from malnutrition in general and severe acute malnutrition (SAM) in particular. According to UNICEF figures, nearly 20 million children under 5 suffer from SAM. Most of these children live in sub Saharan Africa and South Asia. Annually over 1 million children die from severe malnutrition.

The present disclosure generally relates to food products that may provide a therapeutic and/or supplemental source of nutrition for malnourished or undernourished populations, as well as methods for making such products. The food products may be shelf-stable and high energy, and may have high protein content and excellent taste. In some embodiments, the food products may be ready to use therapeutic foods (RUTF), ready to eat foods, ready to cook foods, and/or ready to use supplementary foods.

Historically, RUTF foods that have been provided to people in developing countries have been developed and/or manufactured in a developed country. As a result, the ingredients (such as powdered milk and sugar) in the food are frequently manufactured with products that are unavailable or expensive in the developing country, making it difficult to teach people in that country to manufacture their own foods. Further, palates and flavor preferences are influenced by foods commonly tasted by a person. Thus, food manufactured using non-local ingredients are often less appealing. Accordingly, in one embodiment of the food product, locally available and/or preferred ingredients may be used to make the food product. For example, a post-harvest processing of peanuts into peanut butter may be utilized and the in a controlled mix, nutrients and local ingredients may be added. For example, locally grown crops having appropriate nutritional content may be substituted for common ingredients from developed countries such as powdered milk and sugar. It is to be appreciated that “locally” refers to the in the location where the product is to be consumed.

### SUMMARY

The present invention relates to a food formulation for treating malnourished individuals. The food formulation may be customized to specific target consumer groups. The food formulation further may comprise a majority of locally available ingredients. As such, the food formulation may be manufactured, or partially manufactured, locally. Accordingly, it is possible to teach people in developing countries how to manufacture such food product.

In some embodiments, a food formulation is provided comprising proteins, fats, carbohydrates, and nutritional ingredients, and having a relatively high energy content. The proteins may comprise between about 12 and about 18 percent of the food formulation and may be from one of lentils, dried legumes, tree nuts, and oil seeds. The fats may comprise between about 32 and about 39 percent of the food formulation. The carbohydrates may comprise between about 34 and about 45 percent of the food formulation. The nutritional ingredients may comprise between about 0.4 and about 0.6 percent of the food formulation.

In other embodiments, a food formulation is provided comprising an oil, peanuts, granulated sugar, chickpea flour, vitamin premix, hydrogenated oil, and mono and diglycerides. The oil may be provided in the form of soybean oil, peanut oil, cottonseed oil, or palm oil, and may comprise between about 9 and 13 percent of the food formulation. The peanuts may be provided in the form of roasted whole peanuts or peanut pate, and may comprise between about 20 and 45 percent of the food formulation. The granulated sugar may comprise between about 18 and 24 percent of the food formulation. The vitamin premix may comprise between about 1.6 and 2 percent of the food formulation. The hydrogenated oil may be in the form of hydrogenated cottonseed oil or hydrogenated soybean oil, and may comprise between about 1 and 1.7 percent of the food formulation. The mono and diglycerides may comprise between about 0.4 and 0.6 percent of the food formulation.

In yet other embodiments, a method for making a food formulation is provided. The method may include mixing oil and peanuts, adding hydrogenated oil powder and mono and diglycerides to the oil and peanuts to form a mixture, grinding the mixture to form a ground mixture, and adding sugar, chickpea flour, and vitamins to the ground mixture. No external heat may be supplied during the mixing, adding, grinding, and adding.

While multiple embodiments are disclosed, still other embodiments of the present teachings will become apparent to those skilled in the art from the following detailed description, which shows and described illustrative embodiments. As will be realized, the teachings are capable of modifications in various obvious aspects, all without departing from the spirit and scope of the present teachings. Accordingly, the drawings and detailed description are to be regarded as illustrative in nature and not restrictive.

### BRIEF DESCRIPTION OF THE DRAWINGS

FIG. 1 illustrates a pie chart showing sample percentages of each of proteins, fats, carbohydrates, nutritional ingredients, and fiber and ash in a food formulation in accordance with one embodiment.

FIG. 2 illustrates a table of the mixture of vitamins and minerals used in the ingredients of Example 1.

FIG. 3 illustrates a table of the composition of fats used in the ingredients of Example 1.

FIG. 4 illustrates a table of the nutritional composition of the food formulation created.

FIG. 5 illustrates a report on the nutritional value of a first sample of the composition of food formulation created in Example 1.

FIG. 6 illustrates a report on the nutritional value of a second sample of the composition of food formulation created in Example 1.

FIG. 7 illustrates a report on the nutritional value of a third sample of the composition of food formulation created in Example 1.

FIG. 8 illustrates a report on the nutritional value of a fourth sample of the composition of food formulation created in Example 1.

FIG. 9 illustrates a report on the nutritional value of a fifth sample of the composition of food formulation created in Example 1.

FIG. 10 illustrates a report on the nutritional value of a sixth sample of the composition of food formulation created in Example 1.

FIG. 11 illustrates a fatty acid profile/fat analysis of a sample of the food formulation created in Example 1.

FIG. 12 illustrates a fatty acid profile/fat analysis of a further sample of the food formulation created in Example 1.

FIG. 13 illustrates a nutrition table of the food formulation created in Example 1.

FIG. 14 illustrates a table of the mixture of vitamins and minerals used in the ingredients of Example 2.

FIG. 15 illustrates a table of the composition of fats used in the ingredients of Example 2.

FIG. 16 illustrates a table of the nutritional composition of the food formulation created in Example 2.

FIG. 17 illustrates a further table of the nutritional value of the composition of the food formulation created in Example 2.

FIG. 18 illustrates a table of the mixture of vitamins and minerals used in the ingredients of Example 3.

FIG. 19 illustrates a table of the composition of fats used in the ingredients of Example 3.

FIG. 20 illustrates a table of the nutritional composition of the food formulation created in Example 3.

FIG. 21 illustrates a further table of the nutritional value of the composition of the food formulation created in Example 3.

FIG. 22 illustrates the dietary reference intakes for vitamins for infants, children, males, females, pregnant women, and lactating women.

FIG. 23 illustrates the dietary reference intakes for elements for infants, children, males, females, pregnant women, and lactating women.

FIG. 24 illustrates the dietary reference intakes for macronutrients for infants, children, males, females, pregnant women, and lactating women.

FIG. 25 illustrates the World Food Program fortified blended foods requirements.

### DETAILED DESCRIPTION

The present invention relates to a food formulation for treating malnourished individuals. The food formulation may be customized to specific target consumer groups. The food formulation further may comprise a majority of locally available ingredients. As such, the food formulation may be manufactured, or partially manufactured, locally. Accordingly, it is possible to teach people in developing countries how to manufacture such food product.

In embodiments wherein the food formulation is customized to a specific target consumer group, the target consumer group may have particular nutritional needs and/or cultural preference that may be targeted by the customized food formulation or product. For example, the food product may be formulated to meet the nutritional needs of a particular population, such as lactating women, children under 5 years of age, or children and adults with AIDS, for example.

### Food Formulation

The food formulation may generally comprise proteins, fats, carbohydrates (including sweeteners, for example), and nutritional ingredients that may include moringa, vitamins and minerals, and/or dried fruits and vegetables, and/or other ingredients known to nourish undernourished populations. The selection of ingredients may be based upon what is locally available, and/or preferred, and/or what is needed to treat a given population. The proportion of ingredients provided in a product may be determined by following guidelines that are known in the art for treating various forms of malnutrition, including SAM, in particular populations (for instance, lactating women, children under 1, children under 5, teenagers, adults with compromised immune systems, etc.).

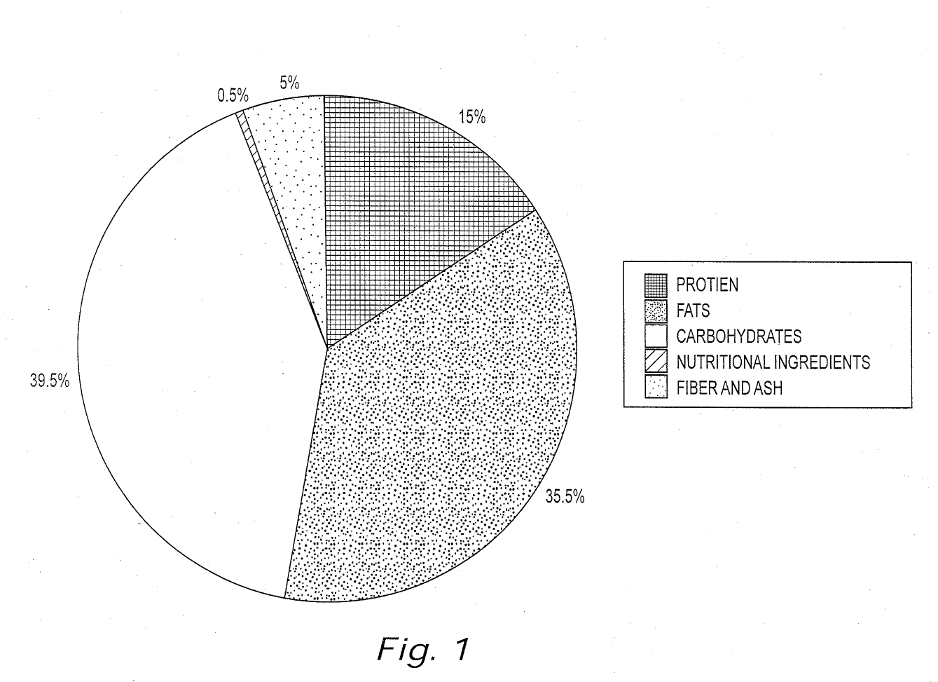

FIG. 1 illustrates a pie chart showing sample percentages of each of proteins, fats, carbohydrates, nutritional ingredients, and fiber and ash in a food formulation according to the teachings herein. Generally, the food formulation may comprise 12-18% proteins, 32-39% fats, 34-45% carbohydrates, 0.4-0.6% nutritional ingredients, and optionally 4-6% fiber and/or ash.

In some embodiments, the food product may include raw chick pea flour, peanut butter, sugar/jaggery, vegetable oil, full fat milk powder, non fat milk powder, corn ground flour, hulled millet, whole wheat, oat, pearled barley, corn meal, ground chick peas (garbanzo), soybeans, and/or ingredients from the following list. It is to be appreciated that chickpea flour used in food formulations in accordance with the teachings herein will typically be preheated to enhance digestibility.

Generally, the food product may include a combination of protein, a fat, a carbohydrate, and nutritional ingredients. Listings of suitable proteins, fats, carbohydrates, and nutritional ingredients are provided below. It is to be appreciated that these lists are intended to be illustrative only and are not intended to be limiting.

### Proteins:

Derived from Milk: casein, milk powder, yogurt, dried whole milk, etc.;
Lentils and dried legumes;
Tree nuts (almonds, cashews, pistachio, pecan, walnuts, etc.);
Oilseeds (peanuts, sunflower seeds, soybeans, pumpkin seeds, sesame, canola, etc.).

### Fats:

Butter, butter oils;
Vegetable oils.

### Carbohydrates (Including Sweeteners):

Grains (white rice, millet, sorghum, oats, barley, rye, etc.);
Malted and sprouted grains;
Refined sugar;
Raw sugar (cane, maple, etc.);
Syrup (cane, maple, etc.);
Honey;
Chocolate.

### Nutritional Ingredients:

Moringa;
Vitamins and minerals;
Dried vegetables (pieces and powders);
Dried fruits (pieces ad powders);
Ready to eat cereals (puffed rice, puffed wheat, etc.).

The exact ingredient used and the amount of the ingredient used may be chosen to address specific nutritional or cultural needs as well as to maximize shelf life and stability. Generally, the food formulation may be manufactured to have the following characteristics (all values listed are approximate and are not intended to be limiting):
Shelf stable (low moisture<2.5% and low water activity<0.3%)
High energy (520-550 kcal/100 gm)
High protein (10%-12% by total energy) (lipids 45%-60% by total energy)
Ready to eat food product
Excellent taste (salt, sweeteners, spices, etc.; sweet or savory; powders, paste, or pieces; smooth or contain particulates)
Consumer appeal
Community based treatment
Using local ingredients and recipes (fortify local foods)

An example formulation comprises:

a % Soybean oil, peanut oil, cottonseed oil, or palm oil;
b % Roasted whole peanuts or peanut pate;
c % Granulated sugar;
d % Chickpea flour;
e % Vitamin premix;
f % Hydrogenated cottonseed oil or hydrogenated soybean oil in powdered form; and
g % Mono and diglyceride in powdered form.

In various embodiments a % may range from 9 to 13, b % may range from 20 to 45, c % may range from 18 to 24, d % may range from 20 to 24, e % may range from 1.6 to 2.0, f % may range from 1 to 1.7, and g % may range from 0.4 to 0.6. It is to be appreciated that more or fewer ingredients may be used.

Examples 1-3 are of specific food formulations.

### Example 1

### Ingredients

### Weight (kg) Ingredient

### 3.09 Soybean oil

11.31 Roasted whole peanuts
6.17 Granulated sugar
6.17 Chickpea flour
0.5 Vitamin premix.
0.417 Hydrogenated cottonseed oil in powdered form
0.141 Mono and diglyceride in powdered form

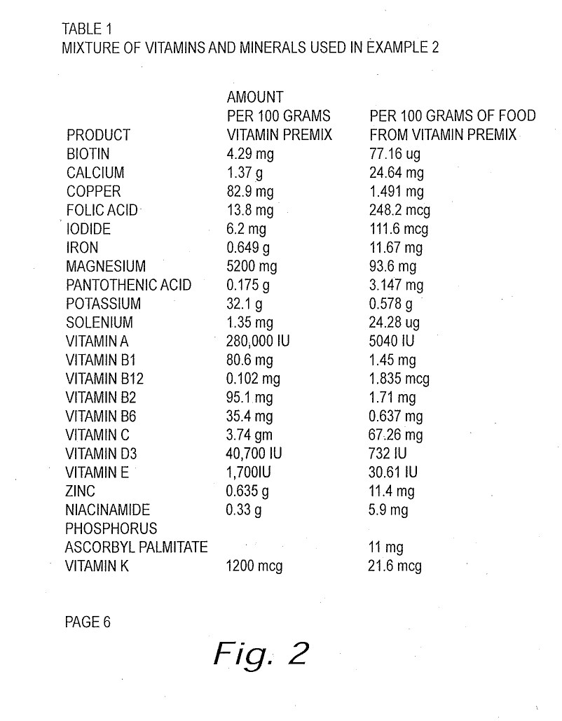

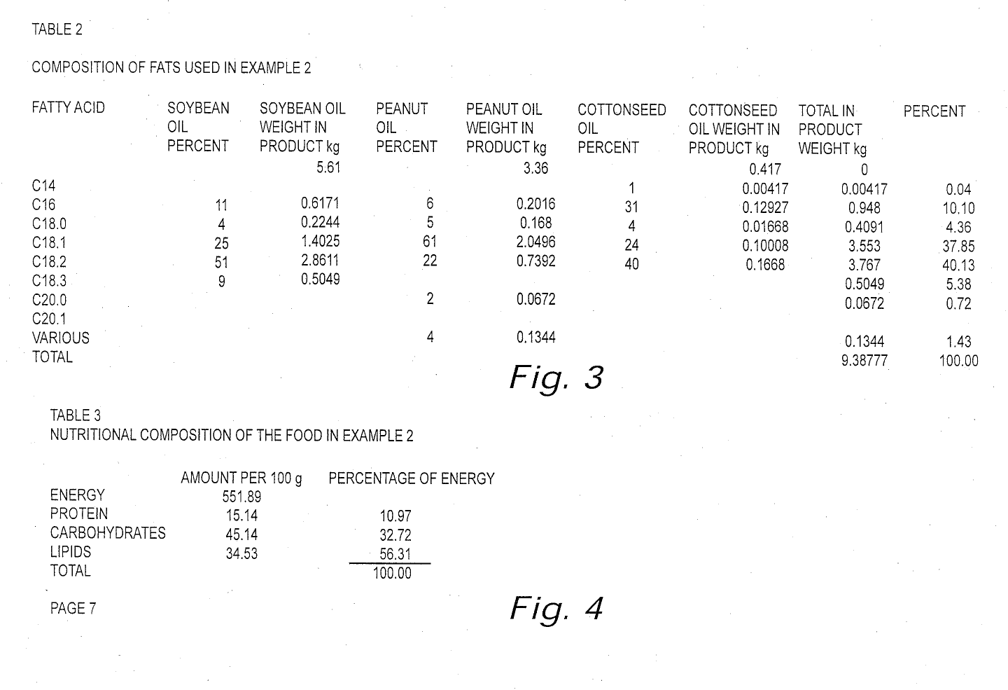

FIG. 2 illustrates a table of the mixture of vitamins and minerals used in the ingredients. FIG. 3 illustrates a table of the composition of fats used in the ingredients.

Step One: The soybean oil (or cottonseed oil in some iterations) and roasted peanuts were placed in a ribbon mixer. The cottonseed oil powder and mono and diglycerides were added to the mixer. Mixing continued for approximately 5 minutes.

Step Two: The blend from Step One was ground using a plate (burr) mill. The ground product was returned to the ribbon mixer.

Step Three: The sugar, chickpea flour and vitamin premix were added to the mixer and mixing continued for 5 minutes.

Step Four: The blend from Step Three was ground with the plate mill to reduce the particle size of the sugar and distribute the emulsifiers.

None of Steps One through Four include heating. The resulting product was a smooth uniform mixture. Product temperature was approximately 90-100 degrees Fahrenheit. Shelf life of 12 months was observed. The oil was stabilized and did not separate in storage comprising packaged unitized servings or bulk lots. The product was shelf stable at room temperature and did not require refrigeration.

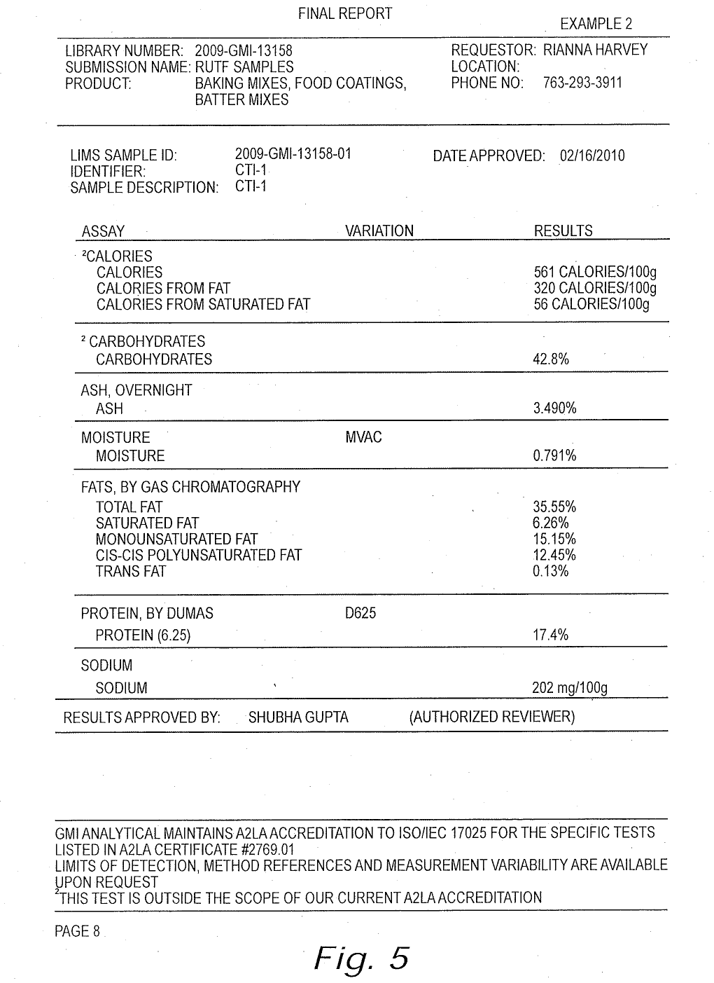

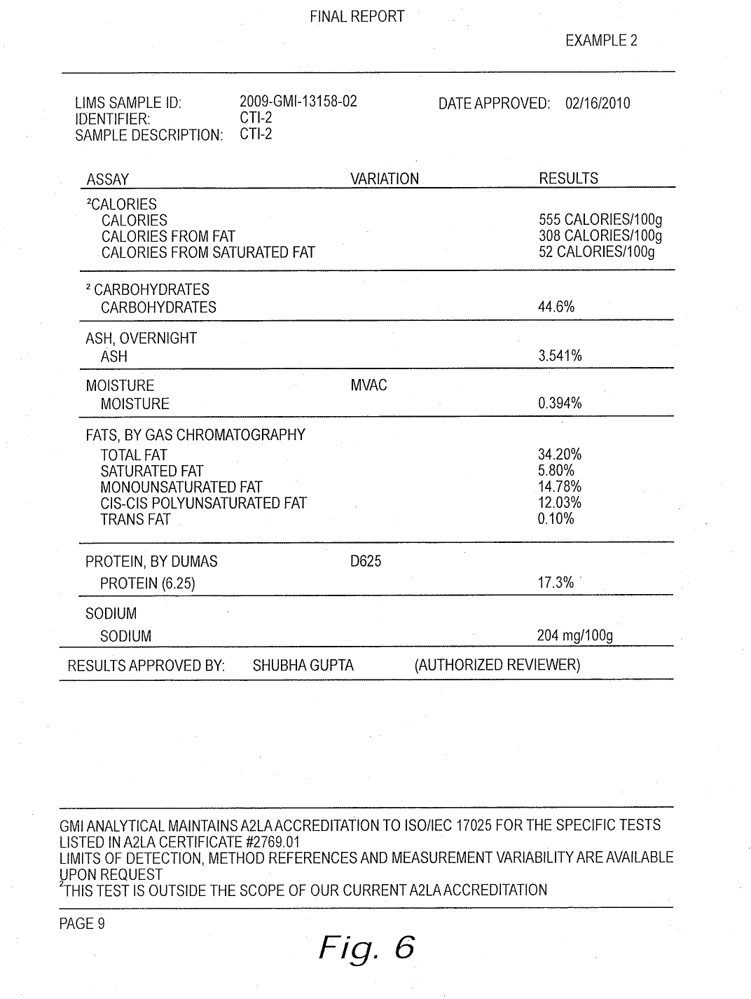

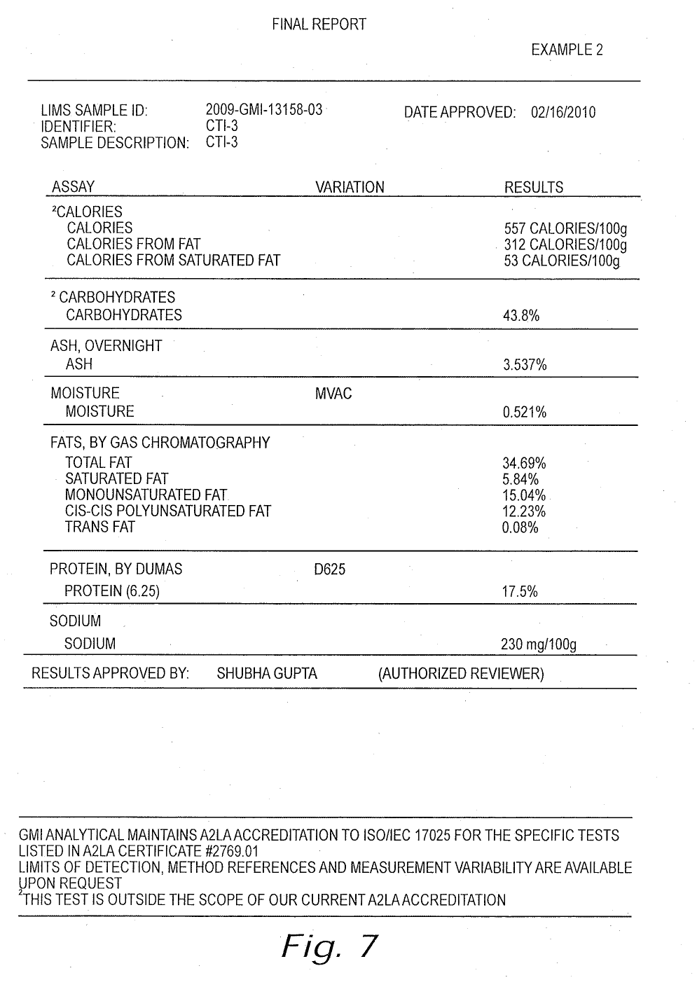

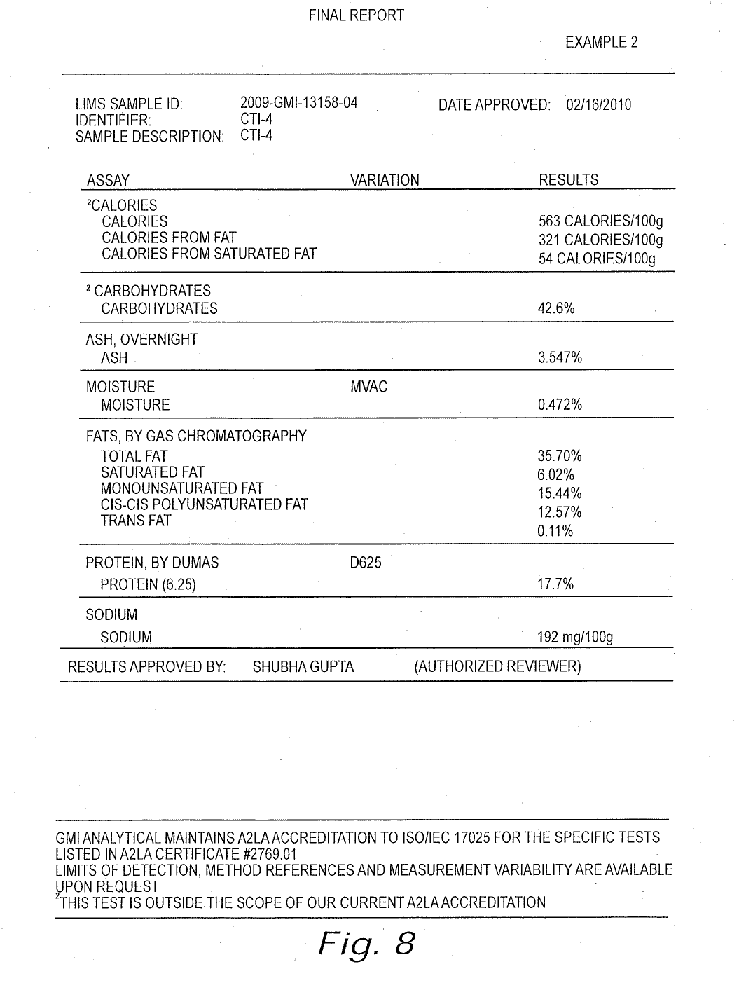

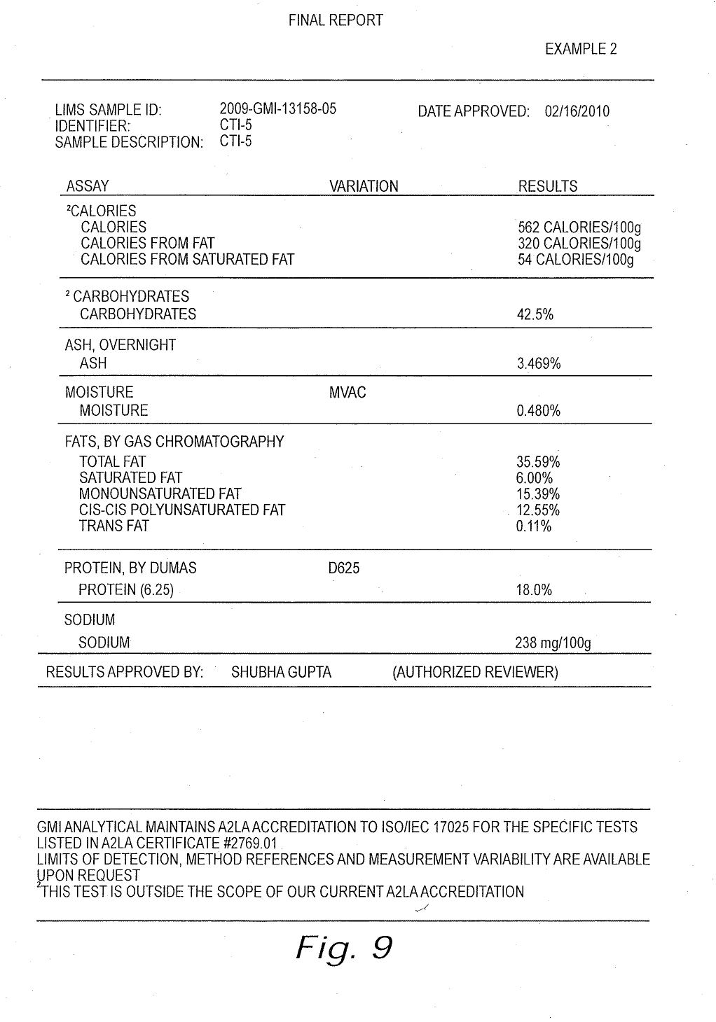

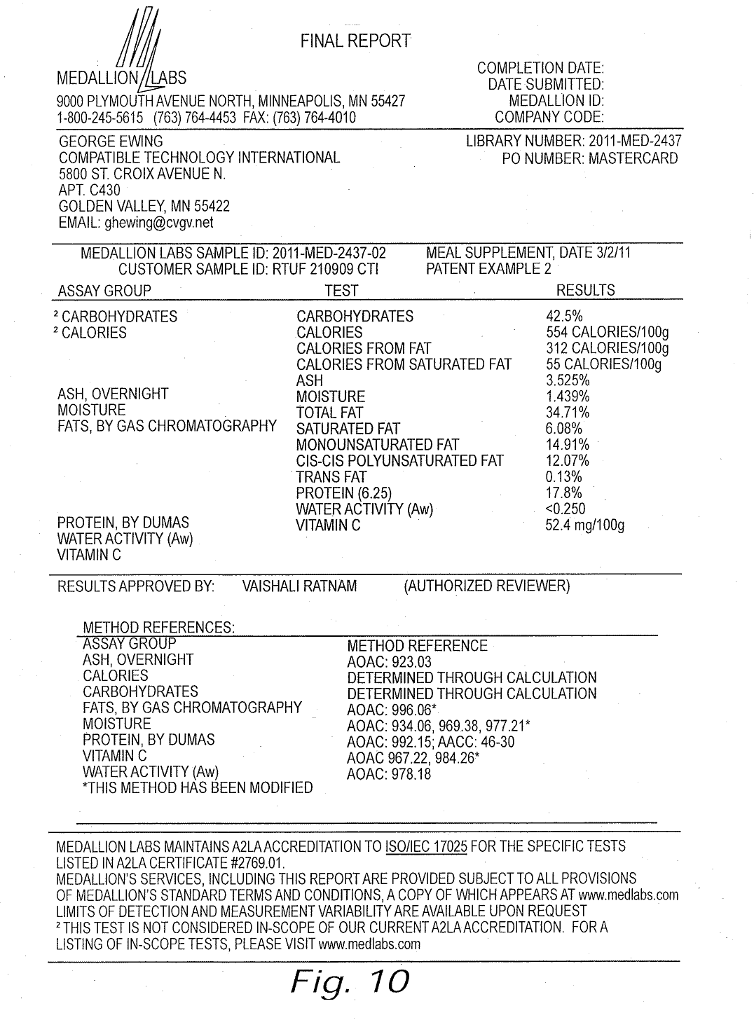

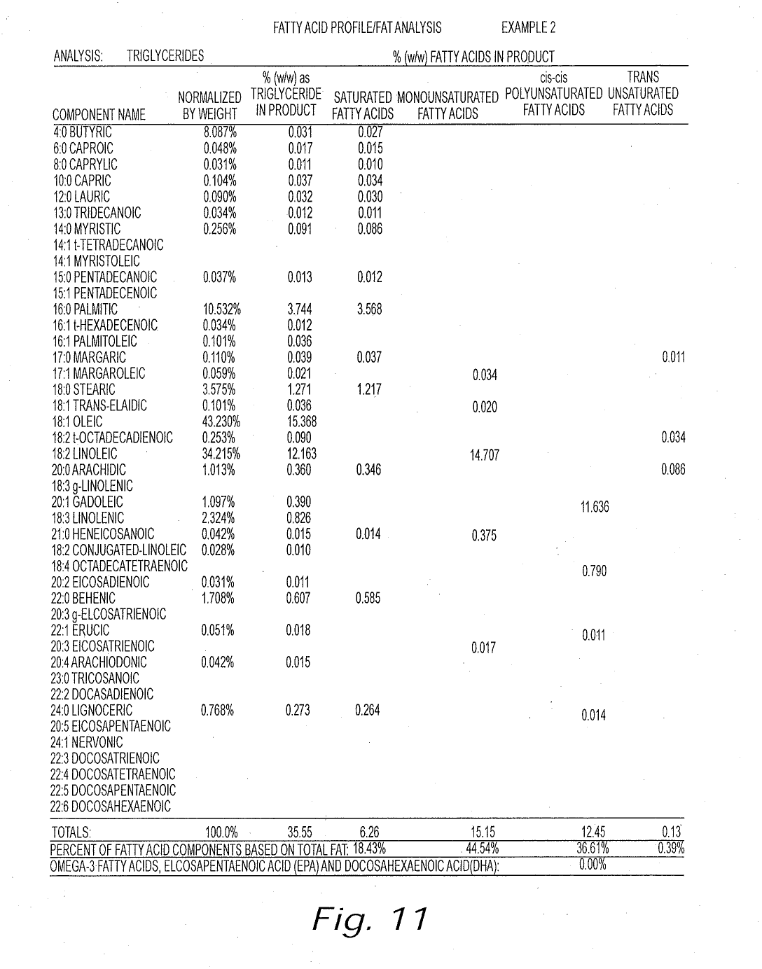

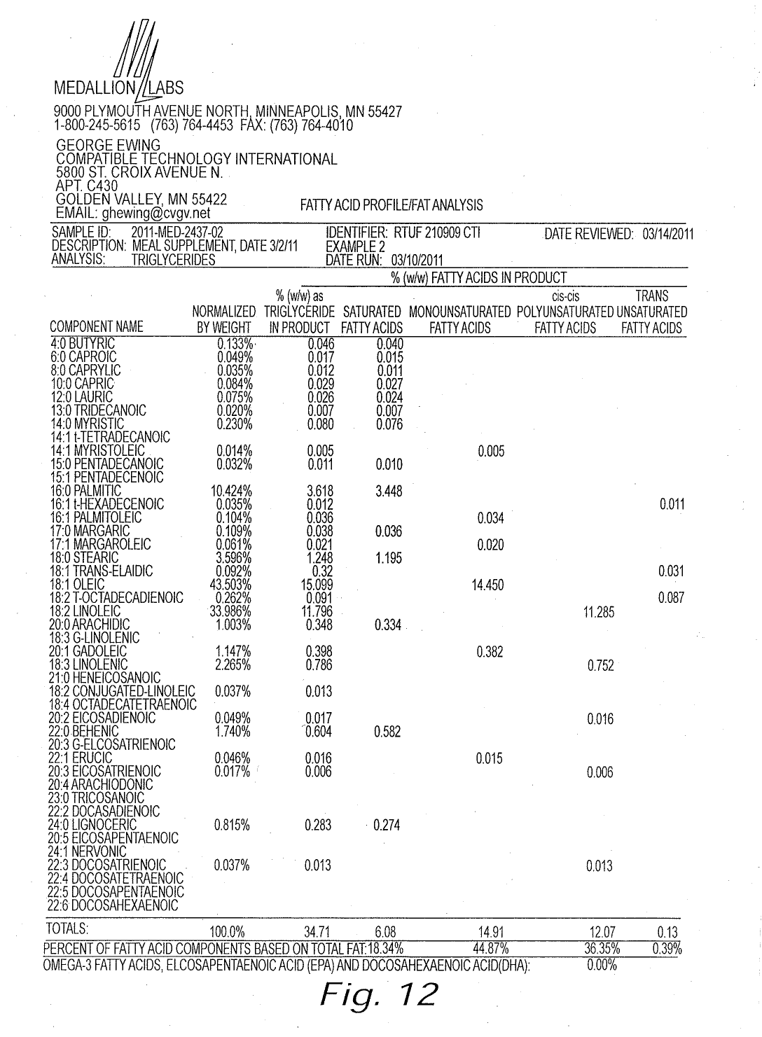

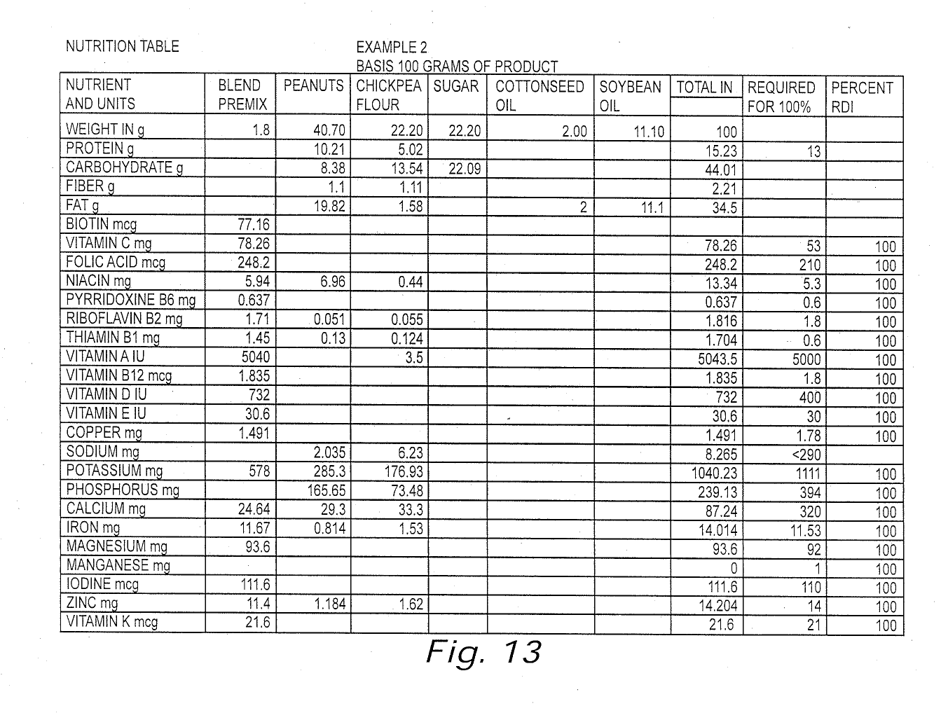

FIG. 4 illustrates a table of the nutritional composition of the food formulation created. FIGS. 5-10 illustrate reports on the nutritional value of the composition of the food formulation created. FIGS. 5-10 illustrate the same information for multiple samples. FIGS. 11 and 12 illustrate fatty acid profile/fat analysis of two samples of the food formulation created. FIG. 13 illustrates a nutrition table of the food formulation created.

A sample of the food formulation of Example 1 was subjected to osmolality testing. The food formulation was put in a 1 oz cup with the top leveled. This was put in a container. 4 volumes of distilled water were added from a 1 oz cup. The food formulation and water were stirred. 5 sub-samples from the mixture were measured on an osmometer. The mixing step was repeated twice for each sub-sample. The results shows 341 mmol/Kg, aw 0.195, and moisture of 1.33%.

### Example 2

### Ingredients

### Weight (kg) Ingredient

### 8.34 Soybean oil

6.645 Nonfat dry milk solids
5.559 Granulated sugar
6.2 Chickpea flour
0.5 Vitamin premix.
0.417 Hydrogenated cottonseed oil in powdered form
0.141 Mono and diglyceride in powdered form

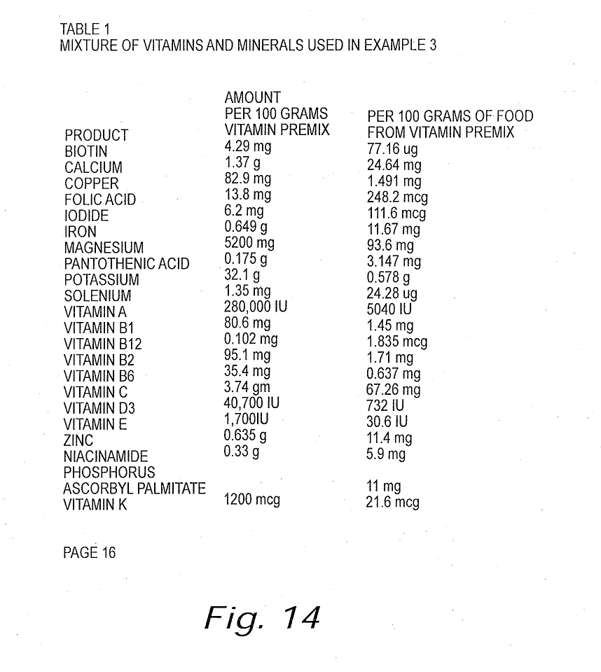

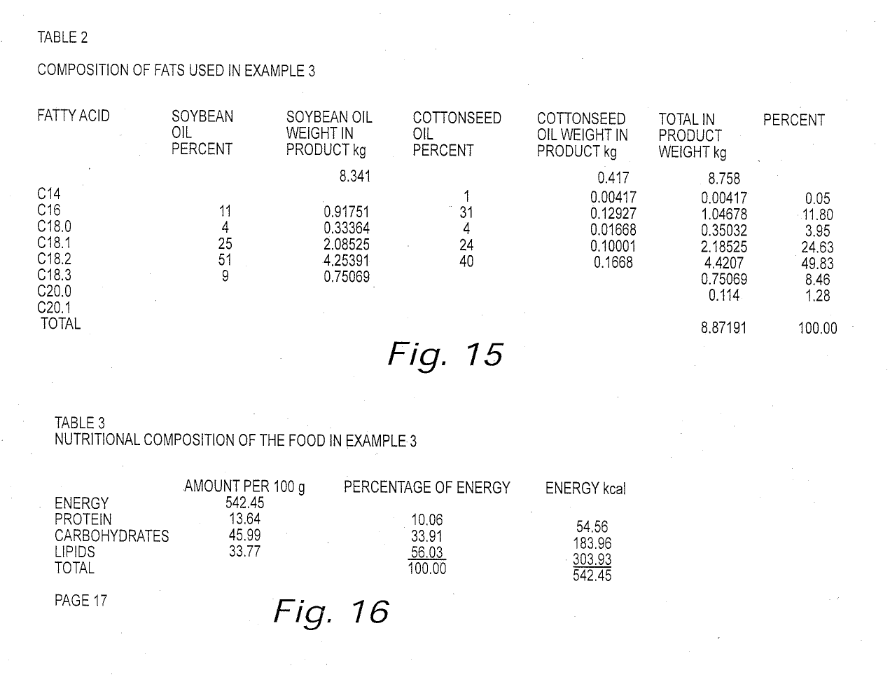

FIG. 14 illustrates a table of the mixture of vitamins and minerals used in the ingredients. FIG. 15 illustrates a table of the composition of fats used in the ingredients.

Step One: The soybean oil, cottonseed oil powder, and mono and diglycerides were placed the mixer. Mixing continued for approximately 5 minutes.

Step Two: The sugar, chickpea flour, nonfat dry milk, and vitamin premix were added to the mixer and mixing continued for 5 minutes.

Step Three: The blend from Step Two was ground with the plate mill to reduce the particle size of the sugar and distribute the emulsifiers.

None of Steps One through Three include heating. The resulting product was a smooth uniform mixture. Product temperature was approximately 90-100 degrees Fahrenheit. The oil was stabilized and did not separate in storage comprising packaged unitized servings or bulk lots. The product was shelf stable at room temperature and did not require refrigeration.

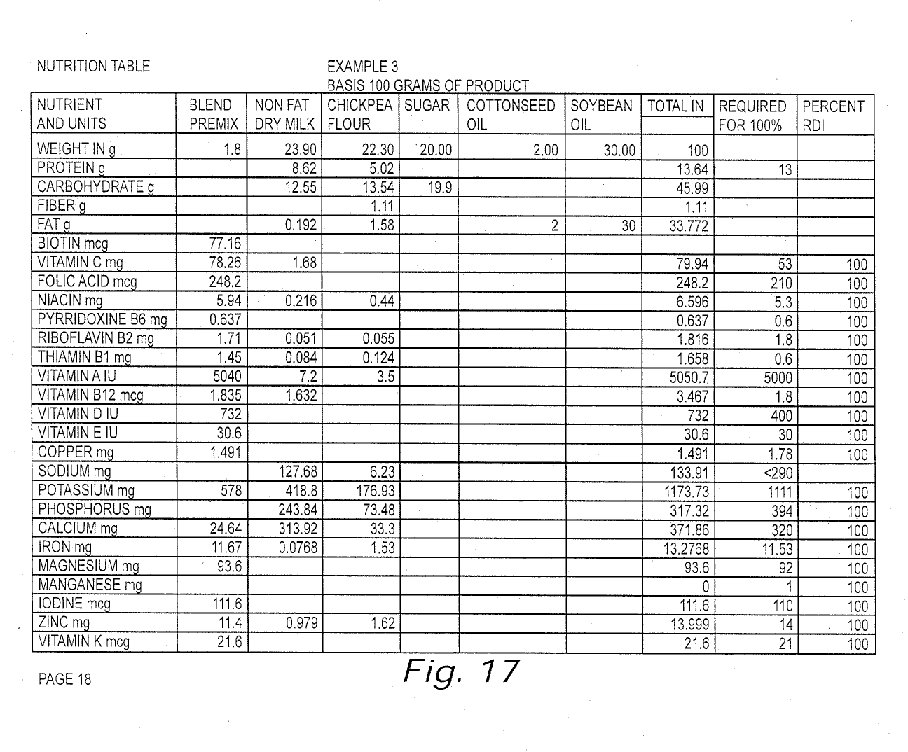

FIG. 16 illustrates a table of the nutritional composition of the food formulation created. FIG. 17 illustrates a further table of the nutritional value of the composition of the food formulation created.

### Example 3

### Ingredients

### Weight (kg) Ingredient

### 8.341 Soybean oil

6.673 Full fat soybean flour
6.173 Chickpea flour
0.5 Vitamin premix.
0.417 Hydrogenated cottonseed oil in powdered form
0.141 Mono and diglyceride in powdered form

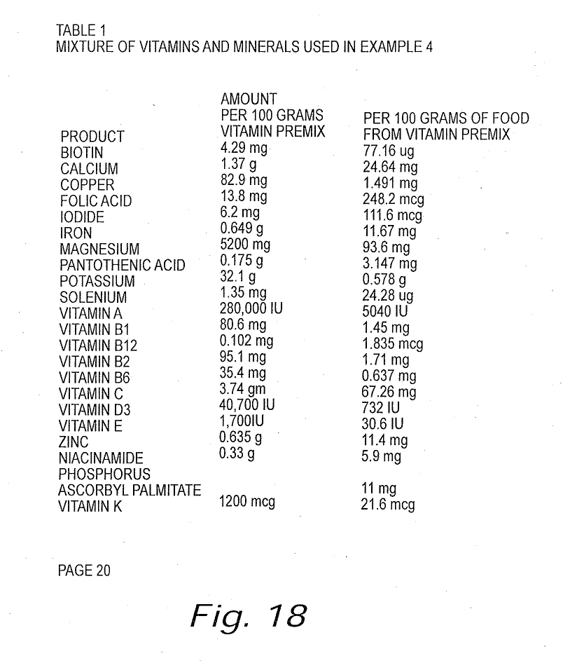

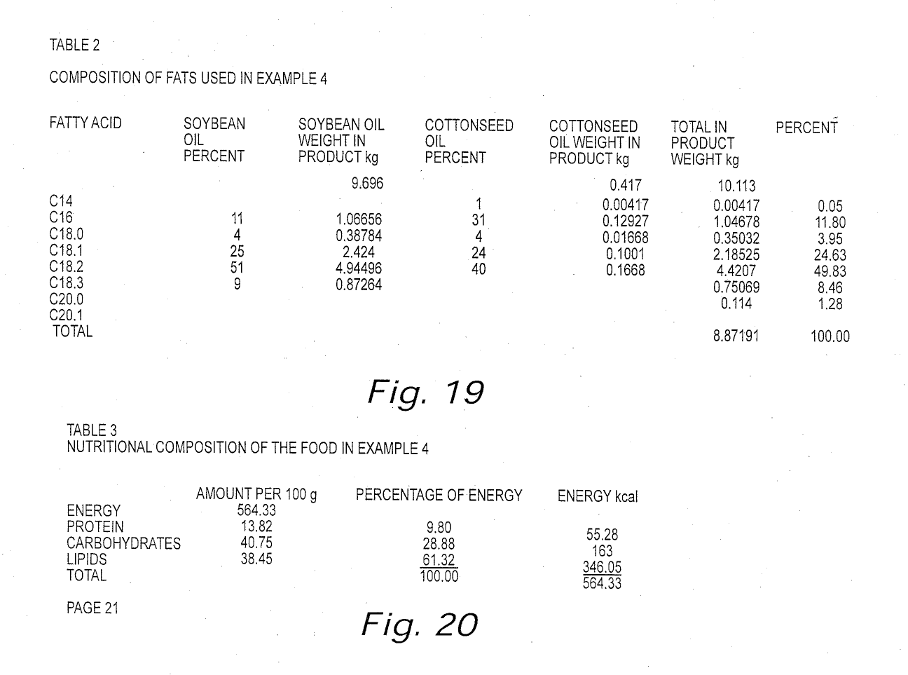

FIG. 18 illustrates a table of the mixture of vitamins and minerals used in the ingredients. FIG. 19 illustrates a table of the composition of fats used in the ingredients.

Step One: The soybean oil, cottonseed oil powder, and mono and diglycerides were placed the mixer. Mixing continued for approximately 5 minutes.

Step Two: The sugar, chickpea flour, full fat soybean flour, and vitamin premix were added to the mixer and mixing continued for 5 minutes.

Step Three: The blend from Step Two was ground with the plate mill to reduce the particle size of the sugar and distribute the emulsifiers.

None of Steps One through Three include heating. The resulting product was a smooth uniform mixture. Product temperature was approximately 90-100 degrees Fahrenheit. The oil was stabilized and did not separate in storage comprising packaged unitized servings or bulk lots. The product was shelf stable at room temperature and did not require refrigeration.

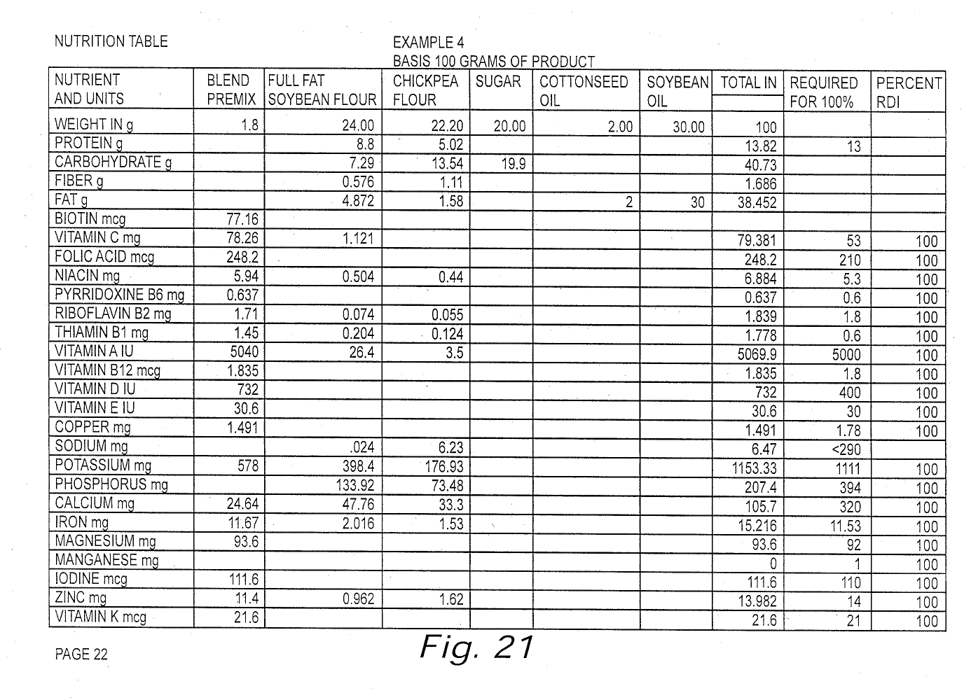

FIG. 20 illustrates a table of the nutritional composition of the food formulation created. FIG. 21 illustrates a further table of the nutritional value of the composition of the food formulation created.

### Customizing Food Formulation for Target Consumer Groups

In some embodiments, the food formulation may be customized to provide the vitamins and minerals appropriate to a target consumer group.

SAM for vitamins and minerals appropriate to target consumer group (added to meet SAM requirements as per UNICEF guidelines, including vitamin A, iron, iodine, zinc, and folic acid), the consumer groups including:
children under 5 years of age;
pregnant and lactating women;
children and adults with AIDS and other debilitating conditions;
disaster relief operations; and
refugee camps.

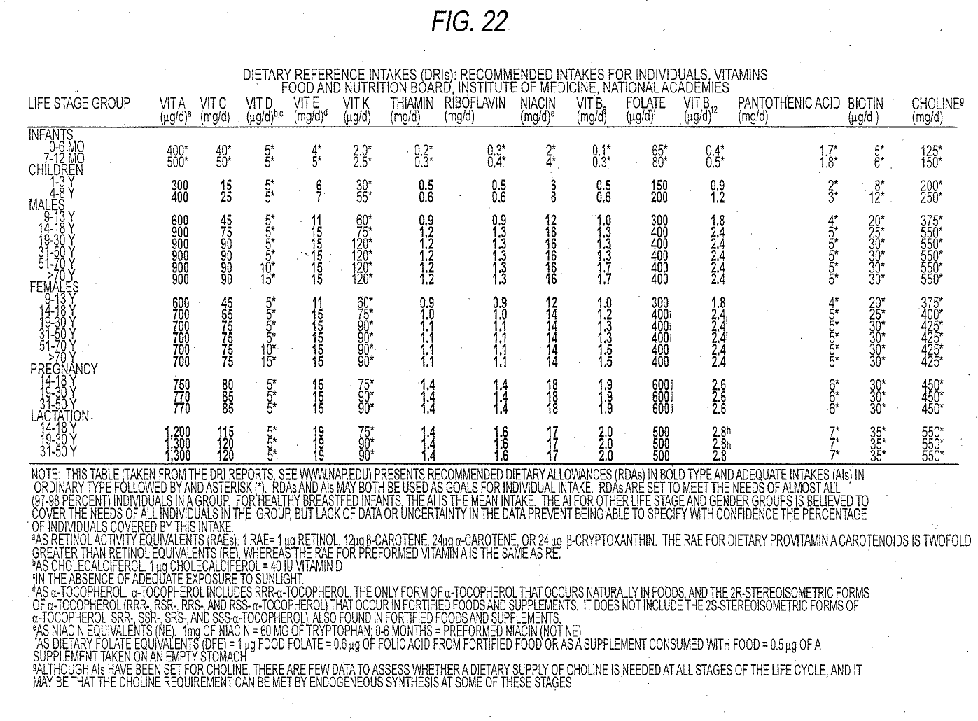

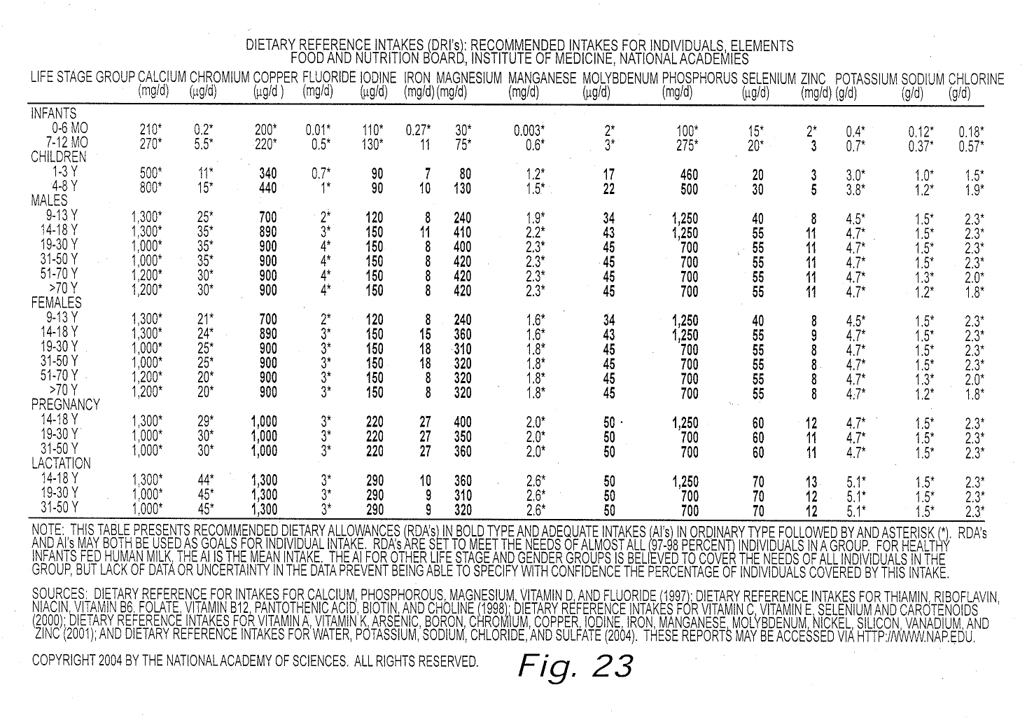

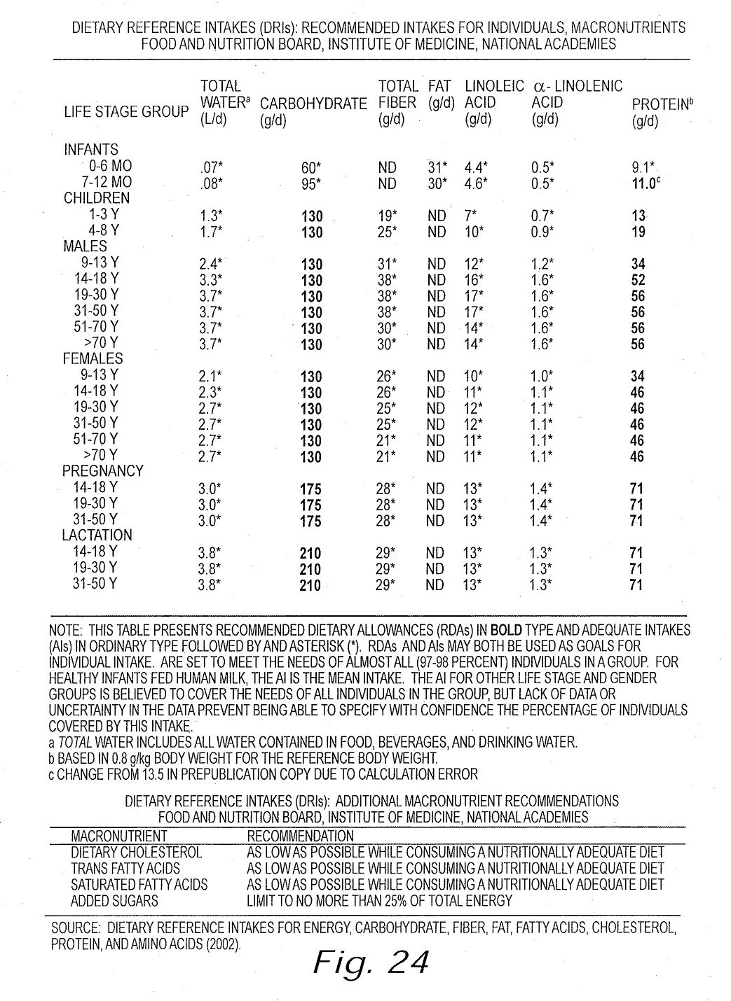

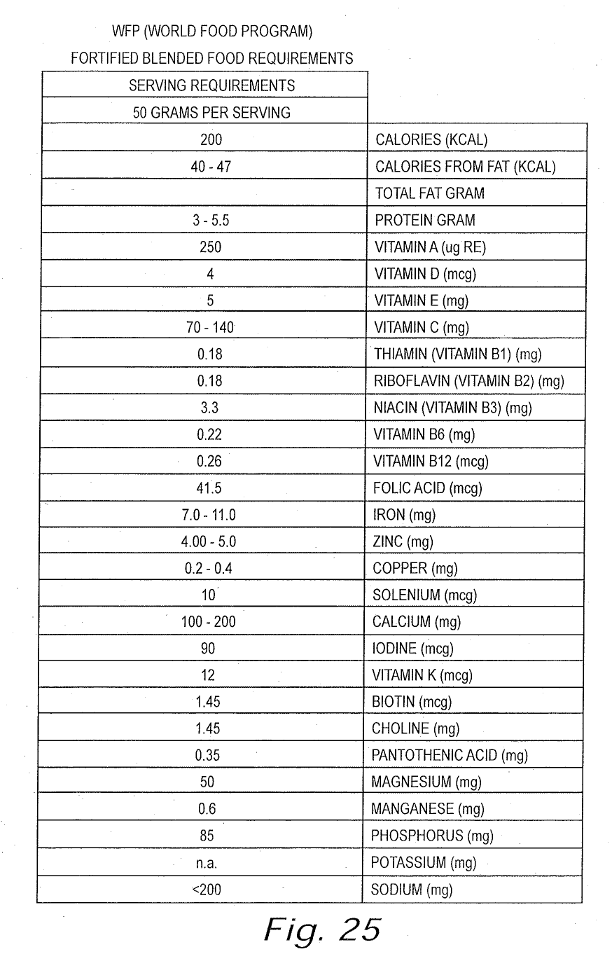

FIGS. 22-25 illustrate tables showing recommended nutritional guidelines for specific target consumer groups. FIG. 22 illustrates the dietary reference intakes for vitamins for infants, children, males, females, pregnant women, and lactating women. FIG. 23 illustrates the dietary reference intakes for elements for infants, children, males, females, pregnant women, and lactating women. FIG. 24 illustrates the dietary reference intakes for macronutrients for infants, children, males, females, pregnant women, and lactating women. FIG. 25 illustrates the World Food Program fortified blended foods requirements.

In some embodiments, the food product may comprise packaged kits that may make it easier to provide unique and customized food products to individuals on-site. For instance, the food products may be adjustable/customizable products that may address particular needs in particular populations, e.g. different age groups, disease states, or nutritional deficiencies. These populations may be referred to as target consumer groups. In some embodiments, the kit may contain a base product that may have a certain nutritional value that may be beneficial for any user, and that may be combined with one of a series of customized supplement packets of vitamins/minerals, etc. and possibly also an additional flavor packet. The base product and supplement product(s) may be combined on-site to create an individualized treatment for a particular person or group of people. One embodiment may be, for example, a base product comprising a biscuit or cookie to which a customizable supplement is added, such as a cream having a nutritional content, that may be spread on the cookie.

In some embodiments, the food product may be formulated to include spices and/or textures to enhance the taste experience of the user. The spices and/or textures may be specifically chosen based on the preferences of the local community that may consume the food product. For example, if the target consumer group is children, the food product may be made more sweet whereas if the targeted consumer group is adult, the food product may be made more savory.

### Method for Making Food Formulation

In some embodiments, a process for making the food product may be relatively uncomplicated and not require electricity, for example. In some cases, the machinery needed for making all or some portion of the food product may be constructed on-site locally by using entirely or mostly materials that may be locally available. The local resources and environment may be considered when developing and, in some cases, customizing, a method for making some or all of a food product. For example, the weather patterns, availability of local water sources, available crops, etc. may be considered.

In some cases, a method for making a food product may include stabilizing the food product by addition of stabilizing agents without using heat. In a specific embodiment, the method may include stabilizing blends of peanut paste and high oil foods by the addition of stabilizing agents without supplying heat other than that provided by a grinding step after blending the materials. The grinding may be done with a plate (burr) mill. When held at room temperature of approximately 75 degrees Fahrenheit, the product may not separate for approximately 4 weeks.

Example 4 is a specific method for manufacturing a food formulation having high stability without requiring heat during manufacture.

### Example 4

Stabilization of embodiments comprising a blend of peanut paste and high oil foods was done by adding stabilizing agents without supplying heat other than that provided by a grinding step after blending the materials.

Hydrogenated cottonseed oil with an iodine value of 5 in a powder form and mono and diglyceride having an iodine value of 5 in a powder form were added to soybean oil at room temperature. The mixture was blended using a planetary mixer. Peanut paste, sugar, nonfat dry milk, and vitamins were added and the mixing was continued until a uniform blend was achieved.

When the blend was completed, the temperature was approximately 85-90 degrees Fahrenheit. This blend was then ground using a plate (burr) mill. The finished particle size was approximately 150 to approximately 200 microns. Temperature after grinding was approximately 90-105 degrees Fahrenheit. The specific gravity of the product was approximately 1.20.

Although the present invention has been described with reference to preferred embodiments, persons skilled in the art will recognize that changes may be made in form and detail without departing from the spirit and scope of the invention.

What is claimed is:

1. A food formulation comprising:
between about 12 and about 18 percent proteins, wherein the protein is from one of lentils, dried legumes, tree nuts, peanuts, and oil seeds;
between about 32 and about 39 percent fats;
between about 34 and about 45 percent carbohydrates; and
between about 0.4 and about 0.6 percent nutritional ingredients;
wherein the food formulation has a relatively high energy content.

2. The food formulation of claim 1, wherein the fat is from one of butter, butter oils, and vegetable oils.

3. The food formulation of claim 1, wherein the carbohydrates are from one of grains, malted and sprouted grains, refined sugar, raw sugar, syrup, honey, or chocolate.

4. The food formulation of claim 1, wherein the nutritional ingredients are from one of moringa, vitamins and minerals, dried vegetables, dried fruits, and ready to eat cereal.

5. The food formulation of claim 1, wherein the food formulation has a moisture content of less than about 2.5%.

6. The food formulation of claim 1, wherein the food formulation has a water activity of less than about 0.3%.

7. The food formulation of claim 1, wherein the food formulation has an osmolality of 341 mmol/KG, aw 0.195, and a moisture of 1.33%.

8. The food formulation of claim 1, wherein the food formulation is targeted to a specific consumer group by tailoring nutrition content of the formulation to the consumer group.

9. The food formulation of claim 1, wherein ingredients of the food formulation are available local to a targeted consumer group.

10. A food formulation comprising:
between about 9 and 13 percent oil;
between about 20 and 45 percent peanuts;
between about 18 and 24 percent granulated sugar;
between about 20 and 24 percent chickpea flour;
between about 1.6 and 2 percent vitamin premix;
between about 1 and 1.7 percent hydrogenated oil; and
between about 0.4 and 0.6 mono and diglyceride.

11. The food formulation of claim 10, wherein the oil is one of soybean oil, peanut oil, cottonseed oil, and palm oil.

12. The food formulation of claim 10, wherein the peanuts are provided in the form of roasted whole peanuts or peanut pate.

13. The food formulation of claim 10, wherein the hydrogenated oil is one of hydrogenated cottonseed oil and hydrogenated soybean oil and is in powdered form.

14. The food formulation of claim 10, wherein the mono and diglyceride are in powdered form.

15. The food formulation of claim 10, wherein the food formulation is provided in a packaged kit.

16. The food formulation of claim 15, wherein the packaged kit may be applied to a base product for providing specific nutritional values.

17. The food formulation of claim 10, wherein the food formulation is targeted to a specific consumer group by tailoring nutrition content of the formulation to the consumer group.

18. A method for making a food formulation, the method comprising:
mixing oil and peanuts;
adding hydrogenated oil powder and mono and diglycerides to the oil and peanuts to form a mixture;
grinding the mixture to form a ground mixture;
adding sugar, chickpea flour, and vitamins to the ground mixture;
wherein external heat is not supplied during the mixing, adding, grinding, and adding.

19. The method of claim 18, wherein the vitamins are a vitamin premix.

20. The method of claim 18, wherein the oil is soybean oil or cottonseed oil.
